(19) United States
(12) Patent Application Publication
(10) Pub. No.: US 2006/0150500 A1
(43) Pub. Date: Jul. 13, 2006

(54) Mat used for a vegetation body

(76) Inventor: Wolfgang Behrens, Gross Ippener (DE)

Correspondence Address: WILLIAM COLLARD;COLLARD & ROE, P.C., 1077 NORTHERN BOULEVARD, ROSLYN, NY, 11576, US

(21) Appl. No.: 10/545,680

(22) PCT Filed: Feb. 19, 2004
(86) PCT No.: PCT/DE04/00320

§ 371 Date: Aug. 15, 2005

(30) Foreign Application Priority Data
Feb. 19, 2003 (DE) 103 07 062.1

(51) Int. Cl. A01G 9/02

(52) U.S. Cl. 47/65.9

(57) ABSTRACT

The invention relates to a mat (10) that is used for a vegetation body, consisting of nonwoven materials, felt or of hygroscopic rock wool and configured to absorb and store water. Said mat (10) contains nutrients (12) for plants.

The invention pertains to a mat that is used for a vegetation body. Such vegetation bodies are conventionally utilized for vegetating roofs and facades of buildings. Flat roofs as well as sloped roofs may be considered in this respect.

Vegetation bodies can be installed, in principle, on all artificial surfaces, e.g., concrete, asphalt, wood, plastic, metal and the like. In one application, the vegetation body is used on natural soil. Vegetation bodies of this type are known, for example, from documents DE 197 40 682 C2, DE 199 34 203 C2 and DE 42 19 275 C2.

Known vegetation bodies usually consist of several layers that are arranged on top of one another. One of these layers consists of a fertile soil layer that contains, in particular, substrates and, if applicable, soil and gravel. In addition, a barrier layer consisting of non-woven material is provided, wherein this layer is able to store water. The roots of the plants growing in the vegetation body can penetrate this barrier layer.

Since they are composed of several layers, known vegetation bodies are relatively thick and heavy. This can affect the handling as well as the transport of the vegetation body.

The invention is based on the objective of developing a mat that has a simpler design, a relatively low weight and a reduced thickness.

This objective is attained with the characteristics of Claim 1 and with another embodiment that is characterized in Claim 10.

According to Claim 1, the mat consists of non-woven materials or felt or of hygroscopic rock wool. The mat contains nutrients for plants and is realized such that it is able to absorb and store water.

In the alternative embodiment disclosed in Claim 10, the mat is composed of an upper and a lower partial mat of non-woven materials or felt or of hygroscopic rock wool. In this case, the partial mats are also realized such that they are able to absorb and store water. Nutrients for plants are applied on the lower partial mat, and the upper partial mat is subsequently placed on the lower partial mat. The two partial mats are then connected to one another, e.g., mechanically with the aid of threads or by means of bonding.

The invention proposes a substrate and storage mat that replaces the above-described fertile soil layer of a vegetation body. For this purpose, nutrients are dispersed in the above-described storage layer of non-woven material. In this case, the storage layer is made of non-woven materials or felt or of hygroscopic rock wool. In the mat according to the invention, the fertile soil layer and the storage layer are combined into a single layer in the form of a mat. This makes it possible to lower the weight and to reduce the thickness of the vegetation body.

It is advantageous that the mat according to the invention can be industrially produced with a uniform thickness. The mat can be coiled up into a roll for storage purposes or manufactured in the form of flat plates. The mat has a low weight and does not contain any sharp edges that could damage the seal of a roof. The mat has a comparatively low weight, requires less storage capacities and is also suitable for being stored over extended periods of time. The mat can be directly vegetated if it is installed on a roof.

According to one advantageous additional development of the invention, the non-woven materials or the felt of the mat has a mass per unit area between 100 g/m² and 10,000 g/m². If the mat is made of hygroscopic rock wool, the volumetric weight of one advantageous embodiment of the invention lies between 30 kg/m³ and 200 kg/m³.

It is practical that the non-woven material of the mat consists of synthetic fibers and/or natural fibers. It was determined that an advantageous non-woven material consists of 60% synthetic fibers and 40% natural fibers, e.g., cotton, flax, hemp or the like.

According to another embodiment of the invention, the nutrients are incorporated into the mat in the form of a dry or liquid substance during its manufacture. In this case, nitrogen, phosphorus and potash are used as nutrients.

In addition to the nutrients, the mat according to another embodiment of the invention also contains trace elements, e.g., of magnesium, manganese, copper, iron or the like. This means that an altogether balanced assortment of nutrients is provided for the plants.

As in initially cited document DE 199 34 203 C2, the mat according to another advantageous embodiment of the invention is provided with holes. This mat allows the wind to pass through and thusly counteracts the suction effect generated on roofs by the wind.

According to another advantageous embodiment of the invention, a layer consisting of a three-dimensional matted fabric with intermediate spaces is arranged on top of the mat. Such matted fabrics are also referred to as loop mats and protect the plants growing in the loop mat from erosion.

According to another additional development of the invention, a layer consisting of a three-dimensional matted fabric containing intermediate spaces is arranged underneath the mat in order to realize the drainage of excess water. The aforementioned matted fabrics can be rigidly connected to the mat or installed in the form of loose layers.

The invention is described in greater detail below with reference to the embodiments illustrated in the figures. The figures show:

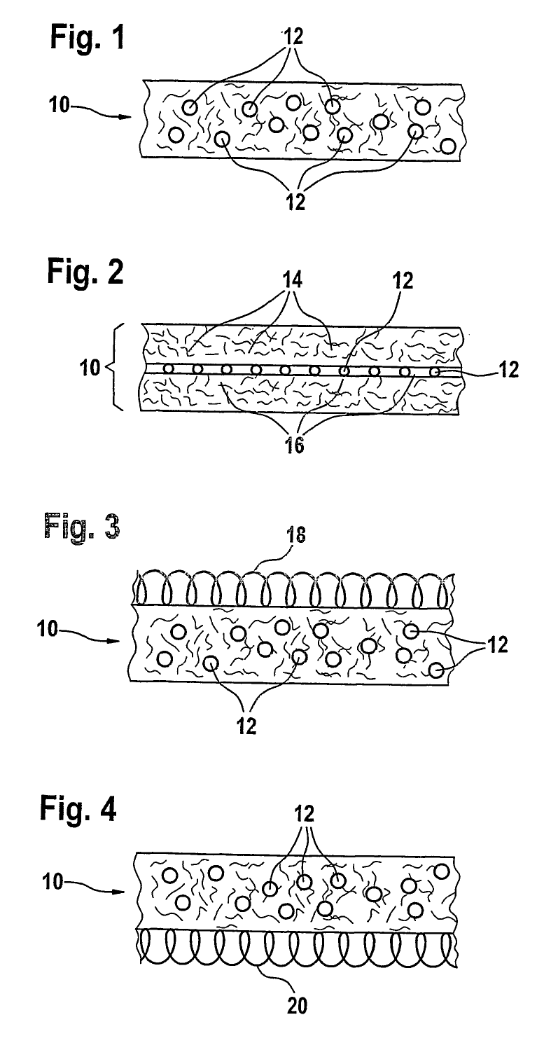

FIG. 1, a schematic cross section through a mat according to the invention;

FIG. 2, a schematic cross section through a mat according to the invention that consists of two partial mats;

FIG. 3, the mat according to FIG. 1 with a matted fabric arranged thereon;

FIG. 4, the mat according to FIG. 1 with a matted fabric arranged thereunder;

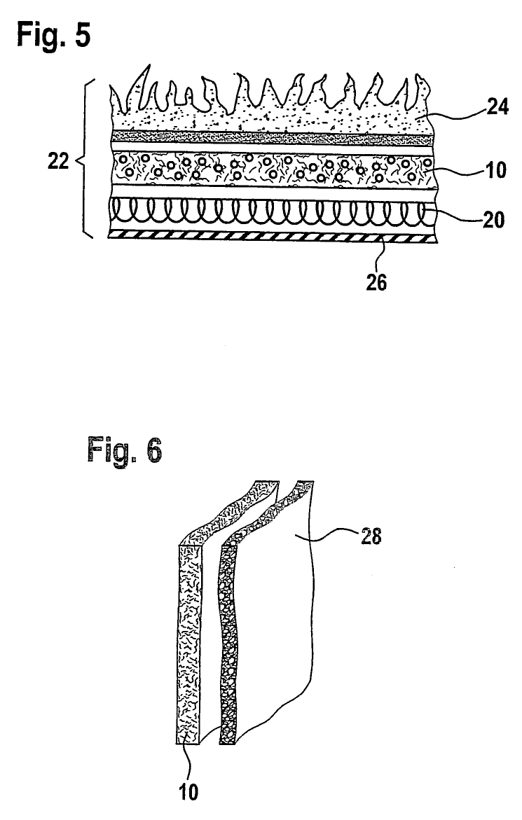

FIG. 5, a schematic cross section through a vegetation body with a mat according to the invention that serves for vegetating a flat roof, and

FIG. 6, a schematic representation of a mat according to the invention for vegetating a facade.

The mat 10 shown in FIG. 1 consists of non-woven materials or felt. Mats of this type are manufactured from recycled products. The mat 10 is able to absorb and store water. Nutrients 12 are dispersed within the mat over the cross section thereof. The nutrients may consist of nitrogen, phosphorus or potash and are incorporated into the mat 10 in dry or liquid form during its manufacture. Trace elements, e.g., of magnesium, manganese, copper, iron or the like are also incorporated into the mat in addition to the nutrients 12. It would also be conceivable to additionally incorporate auxiliary soil materials such as clay, a water-storing granulate, bark humus, loam, activated carbon or the like.

The mat 10 may consist of synthetic fibers as well as natural fibers, e.g., cotton, flax or hemp. It would also be possible to manufacture the mat 10 from a mixture of synthetic fibers and natural fibers. If the mat 10 is made of a non-woven material that has a mass per unit area of 1,200 g/m² and the mat 10 consists of 60% synthetic fibers and 40% natural fibers, the mat 10 is able to store approximately 9 liters of water per square meter.

Instead of utilizing non-woven materials or felt, the mat 10 may also be manufactured from hygroscopic rock wool that contains the nutrients 12, the trace elements and the auxiliary soil materials.

In the mat 10 shown in FIG. 1, the nutrients as well as the trace elements and the auxiliary soil materials are dispersed over the cross section of the mat. An alternative variation of this embodiment is shown in FIG. 2. The mat 10 shown in FIG. 2 consists of an upper partial mat 14 and a lower partial mat 16, both of which consist of non-woven materials, of felt or of rock wool and are able to absorb and store water.

The nutrients 12 as well as the trace elements and the auxiliary soil materials are applied onto the lower partial mat 16. Subsequently, the upper partial mat 14 is placed on the lower partial mat 16 and both partial mats 14, 16 are sewn together. This results in a complete mat 10 with nutrients 12 incorporated therein.

FIG. 3 shows a mat 10 with a three-dimensional matted fabric 18 arranged thereon. Such matted fabrics consisting of synthetic filaments are generally known. In FIG. 3, the upper matted fabric 18 is suitable for protecting plants growing above the mat 10 and within the matted fabric 18 from erosion.

FIG. 4 shows a mat with a bottom layer of matted fabric 20. This matted fabric 20 can be used for drainage purposes in order to drain excess water. The described matted fabrics 18 and 20 may be rigidly connected to the mat 10 or installed in the form of loose layers.

FIG. 5 shows an embodiment of a mat 10 according to the invention, in which the mat forms part of a vegetation body 22 for vegetating a flat roof. The individual layers of the vegetation body 22 are spaced apart from one another in this figure in order to provide a better overview. The mat 10 according to the invention is situated underneath the upper vegetation mat 24. The matted fabric 20 forms a drainage layer underneath the mat 10, and the seal 26 for the flat roof of a house that is not illustrated in the figure lies underneath the drainage layer.

FIG. 6 shows the vegetating of a facade or structure 28. This can be realized by simply fixing the mat 10 according to the invention on the vertical structure 26 [sic], e.g., by bonding the mat 10 to the structure 28. Subsequently, it is possible to directly vegetate the mat 10 that contains nutrients, as well as trace elements and, if applicable, auxiliary soil materials.

1. A mat used for vegetation bodies, wherein:
a) the mat (10) consists of non-woven materials or felt or of hygroscopic rock wool,
b) the mat (10) contains nutrients (12) for plants, and
c) the mat (10) is realized such that it is able to absorb and store water.

2. The mat according to claim 1, wherein the non-woven materials or the felt has a mass per unit area between 100 g/m² and 10,000 g/m².

3. The mat according to claim 1, wherein the volumetric weight of the hygroscopic rock wool lies between 30 and 200 kg/m³.

4. The mat according to claim 1, wherein the non-woven material consists of synthetic fibers and/or natural fibers.

5. The mat according to claim 1, wherein the non-woven material consists of 60% synthetic fibers and 40% natural fibers (cotton, flax, hemp or the like).

6. The mat according to claim 1, wherein the nutrients (12) are incorporated into the mat (10) in the form of a dry or liquid substance during its manufacture.

7. The mat according to claim 6, wherein the nutrients consist of nitrogen N, phosphorus P and potash K.

8. The mat according to claim 6, wherein trace elements, e.g., of magnesium Mg, manganese Mn, copper Cu, iron Fe or the like are incorporated into the mat in addition to the nutrients (12).

9. The mat according to claim 1, wherein the mat (10) contains holes.

10. (canceled)

11. The mat according to claim 1, wherein a layer of a three-dimensional matted fabric (18) with intermediate spaces is arranged on top of the mat (10).

12. The mat according to claim 1, wherein a layer of a three-dimensional matted fabric (20) with intermediate spaces is arranged underneath the mat (10).
